(19) United States
(12) Patent Application Publication
(10) Pub. No.: US 2015/0315914 A1
(43) Pub. Date: Nov. 5, 2015

(54) A METHOD OF BALANCING A TURBINE ENGINE ROTOR, AND A ROTOR BALANCED BY SUCH A METHOD

(71) Applicant: SNECMA, Paris (FR)

(72) Inventor: Geoffroy NICQ, Thomery (FR)

(73) Assignee: SNECMA, Paris (FR)

(21) Appl. No.: 14/650,043

(22) PCT Filed: Dec. 3, 2013
(86) PCT No.: PCT/FR2013/052926

§ 371 Date: Jun. 5, 2015

(30) Foreign Application Priority Data
Dec. 10, 2012 (FR) 1261830

(51) Int. Cl. F01D 5/10; G01M 1/32; F16F 15/34

(52) U.S. Cl. CPC F01D 5/10; F16F 15/34; G01M 1/32

(57) ABSTRACT

A method of balancing a turbine engine rotor, the method including mounting screws forming balance weights on the rotor in order to form a balance configuration, each screw possessing a predetermined weight and a screw head having a visual characteristic previously associated with its weight. A rotor balanced by such a method is also disclosed.

### BACKGROUND OF THE INVENTION

The present invention relates to the general field of balancing a turbine engine rotor, and in particular a fan of an airplane turbojet.

In known manner, a turbojet comprises a fan feeding air to a primary flow channel containing in particular a low pressure compressor, a high pressure compressor, a combustion chamber, a high pressure turbine, and a low pressure turbine.

At its upstream end, the turbojet has an air inlet for feeding the fan, which comprises in particular a disk having mounted thereon blades that are circumferentially spaced apart from one another. An inlet cone fastened on the disk of the fan serves to deflect the air that is admitted into the turbojet towards the blades of the fan.

In order to compensate for unbalance affecting the fan in rotation while the turbojet is in operation, and thus in order to reduce the vibration of the engine, it is known to balance the fan by using screws that form balance weights that are engaged in the disk or in the inlet cone. More precisely, these screws present lengths that are different from one another so as to give them different weights. The number, the positions around the axis of rotation of the fan, and the lengths of the screws define a balancing configuration for the fan on which they are installed.

Likewise, in order to compensate for the unbalance affecting the low pressure turbine when it is rotating while the turbojet is in operation, clips are mounted on the free ends of the blades of the last stage of the turbine. The numbers and positions of these clips define a balancing configuration for the low pressure turbine on which they are installed.

When calculating a new balancing solution, it is important for the balancing configurations for the fan and for the low pressure turbine that have actually been installed to be known. For this purpose, the balancing configurations are stored in the electronic monitoring unit (EMU) of the engine. Calculating a new balancing configuration thus implies that the EMU has stored in memory the configurations of the screws installed in the fan and of the clips mounted on the last stage of the low pressure turbine. Unfortunately, in the event of the EMU being replaced, those balancing programs as stored in memory are lost and it is necessary to reinitialize the memory of the new EMU with the configurations of the screws actually installed on the fan and of the clips mounted on the last stage of the low pressure turbine.

In order to discover the configuration of the screws installed on the fan, it is therefore necessary to unscrew each screw, to observe its length in order to know its weight, and then to screw it back in. Likewise, in order to know the configuration of the clips mounted on the blades of the last stage of the low pressure turbine, it is necessary either to partially dismantle the rear end of the engine, or else to use a special tool for accessing that stage together with appropriate viewing means. Such inspection operations are laborious and they require qualifications that the technician in charge of reinitializing the EMU memory need not necessarily possess.

### OBJECT AND SUMMARY OF THE INVENTION

The present invention thus has the main aim of mitigating such drawbacks by proposing a method of balancing the fan without presenting the above-specified drawbacks.

This object is achieved by a method of balancing a turbine engine rotor, the method comprising mounting screws forming balance weights on the rotor in order to form a balance configuration, each screw possessing a predetermined weight and a screw head having a visual characteristic previously associated with its weight.

Each screw forming a balance weight presents a screw head with a particular visual characteristic that is associated with its weight and that can be detected directly by the naked eye (the screw heads do not match). Thus, during an operation of reinitializing the memory of the EMU of the engine, the balance weights that are mounted on the rotor, e.g. on the fan of the turbine engine, are identified merely by looking at the screw heads and comparing their characteristics with a pre-established table. In particular, there is no need for the technician in charge of this operation to unscrew each screw in order to discover its weight. As a result, the operation of reinitializing the EMU with the balance configuration of the rotor is quick and does not require any special competence.

Preferably, the method includes a prior step consisting in establishing a table in which each particular visual characteristic of a screw head is associated with a predetermined screw weight. The visual characteristics of the screw heads may consist in particular shapes and/or colors.

Also preferably, the balance configuration is stored in a memory of an electronic computer of the turbine engine and is then transmitted automatically to a database of a maintenance center. Thus, the installed balance configuration may be transmitted to a technician during an operation of replacing the electronic computer. Likewise, in the event of vibration being detected in operation, a balance recommendation may be calculated by the maintenance center and the recommendation may be transmitted to a technician, in particular in order to be installed on the fan.

The invention also provides a turbine engine rotor including screws forming balance weights that are mounted on the rotor, each screw possessing a predetermined weight and a screw head having a visual characteristic previously associated with its weight.

Screw heads may be of different shapes. The shapes of the screw heads may be selected from square, round, hexagonal, cross-shaped, star-shaped, and ring-shaped.

Screw heads may have different colors. The rotor may constitute a turbine engine fan.

The invention also provides a turbine engine fitted with a rotor as defined above or that is balanced using the method as defined above.

### BRIEF DESCRIPTION OF THE DRAWINGS

Other characteristics and advantages of the present invention appear from the following description made with reference to the accompanying drawings, which show an embodiment having no limiting character. In the figures:

FIG. 1 is a diagrammatic perspective view of a fragment of a turbojet fan balanced by the invention;

FIG. 2 shows an example of different heads for screws used as balance weights for balancing the FIG. 1 fan; and

FIGS. 3A and 3B show example applications of the method of the invention.

### DETAILED DESCRIPTION OF THE INVENTION

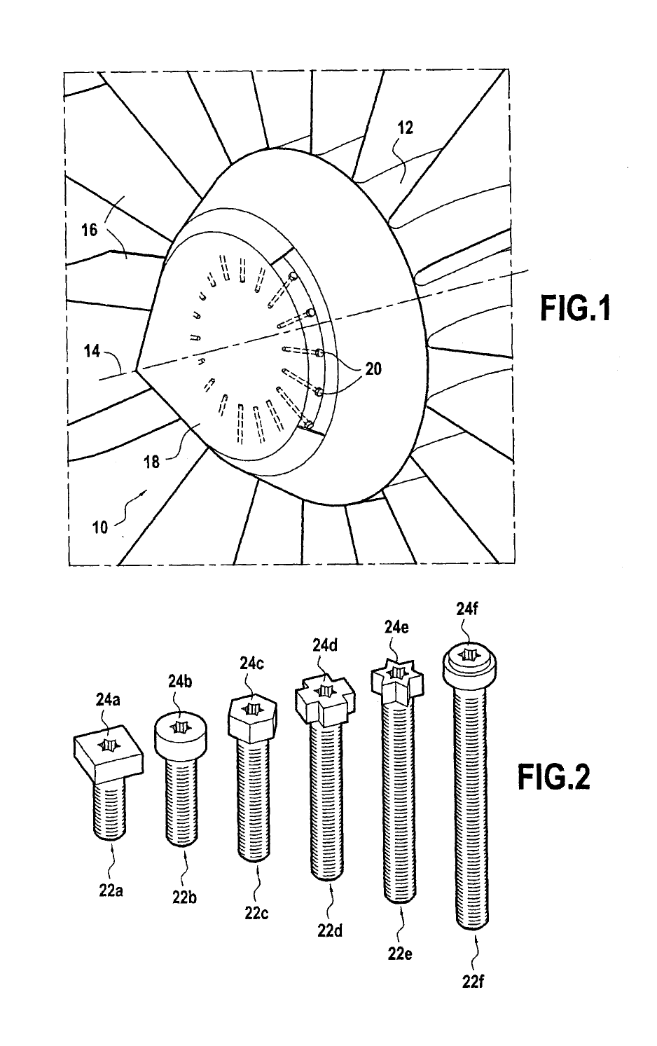

The invention applies to any turbine engine rotor, and in particular to a turbojet fan such as that which is shown in very diagrammatic manner in FIG. 1.

In known manner, the fan 10 of a turbojet comprises in particular a disk 12 centered on an axis of rotation 14 and having mounted thereon blades 16 that are circumferentially spaced apart from one another. An air inlet cone 18 is fastened to the disk 12 upstream therefrom in order to deflect the air admitted into the turbojet towards the blades 16 of the fan.

The fan 10 also has a plurality of holes 20 (e.g. twenty such holes) that are regularly spaced around its axis of rotation 14. By way of example, these holes 20 are formed in the outer periphery of the air inlet cone 18. Alternatively, they may be formed directly in the disk 12 of the fan.

In the embodiment of FIG. 1, these holes 20 extend in a radial direction and they present right sections of circular shape and of the same diameter.

The holes 20 are for receiving screws 22a to 22f (FIG. 2) that form balance weights. As shown in FIG. 2, these screws 22a to 22f all have the same diameter but they are of different lengths, thus making it possible to obtain a batch of screws having different weights.

The number, the angular positions around the axis of rotation 14 of the fan, and the weights of the screws 22a to 22f mounted on the air inlet cone of the fan define a balance configuration of the fan that is installed thereon for the purpose of reducing the vibration of the low pressure spool of the turbojet while it is in operation.

Such a balance configuration of the fan is specific to each engine and is determined at the time the engine is delivered. The way in which this configuration is determined and then converted into terms of angular positioning of balance weights on the fan is well known to the person skilled in the art and is not described in detail herein.

Furthermore, each screw 22a to 22f having a particular length (i.e. a particular weight) is associated with a screw head 24a to 24f that has a particular visual characteristic.

The term “visual characteristic” is used herein to mean a characteristic of shape and/or color that enables the screws to be distinguished from one another by the naked eye.

FIG. 2 thus shows six variant screws 22a to 22f. These screws 22a-f are of mutually different lengths (and thus weights). They also have screw heads 22a to 24f of visual characteristics that are mutually different (the heads of the screws do not match).

In the embodiment of FIG. 2, these visual characteristics consist in screw head shapes that are visually different from one another: the screw head 24a of the screw 22a has a square shape, the screw head 24b has a circle shape, the screw head 24c has a hexagonal shape, the screw head 24d has a cross shape, the screw head 24e has a star shape, and the screw head 24f has a ring shape.

In another embodiment (not shown in the figures), the visual characteristics of the screw heads consist in colors that differ visually from one another: one screw head may be red in color, another may be green, another may be yellow, another may be blue, another may be black, another may be white, etc.

Having recourse to a color code for distinguishing the screws from one another requires making use of a paint that can withstand the difficult conditions to be found in the operation of the engine, i.e. capable of withstanding thermal shocks, sand impacts, etc.

Furthermore, a correspondence table is established beforehand to be consulted by a technician who does not necessarily have the qualifications for balancing a fan. This table lists each screw that is suitable for use as a balance weight in the fan together with its associated screw head shape that is associated with the corresponding screw weight.

As a result, using this table, a technician seeking to identify the balance configuration of the fan that has previously been installed thereon can, merely by visually inspecting the screw heads and without any need to remove the screws, quickly, simply, and reliably recognize the configuration of the balance weight. For this purpose, the technician visually inspects the screw heads mounted on the fan and identifies the corresponding weight by referring to the correspondence table. This leads to a considerable saving in time and enables the technician to perform this operation without needing special competence.

The balancing method of the invention can advantageously be implemented in various situations.

In an initial step, the engine is balanced for delivery. More precisely, balancing is performed in two planes, namely the plane of the fan in accordance with the method of the invention and in the plane of the low pressure turbine by adding clips to the tips of the blades of the last stage of the low pressure turbine.

Once the engine has been balanced, the balance configurations of the fan and of the low pressure turbine are stored in a memory internal to the electronic monitoring unit (EMU), and then advantageously automatically transmitted to a database of a center in charge of the maintenance of all of the operator's engines.

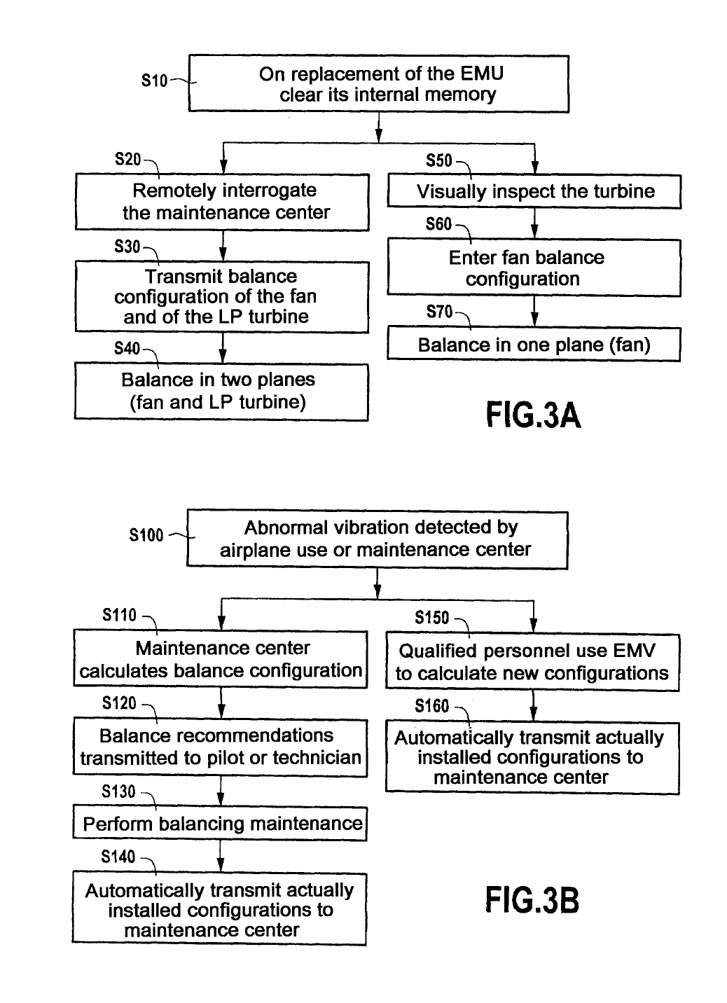

A first situation in which the method of the invention may be performed is that of replacing the EMU (FIG. 3A). During this maintenance operation performed by a technician, the internal memory of the EMU is reinitialized (step S10).

The technician in charge of replacing the EMU then remotely interrogates the maintenance center (step S20), which returns the balance configurations previously installed on the fan and the low pressure turbine (S30). The balance configuration of the fan can also be identified visually by inspecting the screw heads as described above.

In this way, the technician can reinitialize the memory of the new EMU with the balance configurations actually installed both on the fan and on the low pressure turbine. In particular, the technician has no need to remove the balance screws from the fan nor to have access to the last stage of the low pressure turbine in order to discover these balance configurations.

The balancing of the engine that is initialized in this way in the internal memory of the new EMU gives information about two planes, namely the plane of the fan and the plane of the low pressure turbine (step S40).

In contrast, if the technician is not able to remotely interrogate the maintenance center or does not have appropriate tools or qualifications for accessing the last stage of the low pressure turbine, the technician can make do with visually identifying the balance configuration of the fan (step S50) merely by visually inspecting the screw heads as described above.

The balance configuration of the fan as identified in this way can then be initialized in the internal memory of the new EMU (step S60). It should be observed that the balancing of the engine as initialized in this way in the internal memory of the new EMU has information about one plane only, namely the plane of the fan (step S70), but that covers the great majority of needs and balancing operations.

A second situation in which the method of the invention may be performed is that of detecting abnormal vibration on the airplane making it necessary to change the balancing of the engine (FIG. 3B).

Such abnormal vibration may be detected by the user of the airplane or directly by the maintenance center (step S100) that receives vibration data from the airplane in flight for this purpose.

When the maintenance center detects such abnormal vibration, it may itself calculate new balance configurations for the fan and for the turbine (step S110).

These balancing recommendations are then transmitted directly to the pilot of the airplane or to the technician (step S120), with it being left to them to install them on the engine. For this purpose, the airplane has a maintenance pack containing balance screws for balancing the fan and clips for balancing the low pressure turbine. Thus, the balancing maintenance operation (step S130) can be performed by a technician without it being necessary for the technician to possess special competence in this domain.

The balance configurations actually installed on the engine as a result of this balancing maintenance operation are then stored in the internal memory of the EMU and transmitted automatically to the maintenance center (step S140).

Alternatively, new balance configurations for the fan and the turbine following the detection of abnormal vibration may be calculated by qualified personnel directly on the airfield by using the EMU (step S150).

These new balance configurations actually installed on the engine are then stored in the internal memory of the EMU and transmitted automatically to the maintenance center (step S160).

1-12. (canceled)

13. A method of balancing a turbine engine rotor, the method comprising mounting screws forming balance weights on the rotor in order to form a balance configuration, each screw possessing a predetermined weight and a screw head having a visual characteristic previously associated with its weight.

14. A method according to claim 13, including a prior step of establishing a table in which each particular visual characteristic of a screw head is associated with a predetermined screw weight.

15. A method according to claim 13, wherein the visual characteristics of the screw heads include particular shapes and/or colors.

16. A method according to claim 13, wherein the balance configuration is stored in a memory of an electronic computer of the turbine engine and is then transmitted automatically to a database of a maintenance center.

17. A method according to claim 16, wherein the installed balance configuration is transmitted to a technician during an operation of replacing the electronic computer.

18. A method according to claim 16, wherein a balance recommendation is calculated by the maintenance center in the event of vibration being detected in operation, and the recommendation is transmitted to a technician.

19. A turbine engine rotor including screws forming balance weights that are mounted on the rotor, each screw possessing a predetermined weight and a screw head having a visual characteristic previously associated with its weight.

20. A rotor according to claim 19, wherein the screw heads are of different shapes.

21. A rotor according to claim 20, wherein the screw head shapes are selected from square, round, hexagonal, cross-shaped, star-shaped, and ring-shaped.

22. A rotor according to claim 19, wherein the screw heads are of different colors.

23. A rotor according to claim 19, said rotor forming a fan.

24. A turbine engine having a rotor according to claim 19.
